(19) United States
(12) Patent Application Publication
(10) Pub. No.: US 2008/0271563 A1
(43) Pub. Date: Nov. 6, 2008

(54) Folding Shooter Bench

(76) Inventor: Franco Liu, Taoyuan Hsien (TW)

Correspondence Address: TROXELL LAW OFFICE PLLC, 5205 LEESBURG PIKE, SUITE 1404, FALLS CHURCH, VA, 22041, US

(21) Appl. No.: 11/886,322

(22) PCT Filed: Nov. 9, 2005
(86) PCT No.: PCT/CN2005/001882

§ 371 Date: Sep. 14, 2007

(30) Foreign Application Priority Data
Mar. 17, 2005 (CN) 200520008604.7
May 17, 2005 (CN) 200520019147.1

(51) Int. Cl. F16K 31/05

(52) U.S. Cl. 74/625

(57) ABSTRACT

A clutch driving structure coupled to a driving motor comprises a retarder (3), a clutch (4), an electronic pedometer (5), and a door position controller (6) mounted inside a housing (2) on the driving motor (1). By coupling the above-mentioned components with the driving motor (1), the transmission apparatus of the roller door is provided with convenient disassembly and maintenance. Besides, the conventional components for controlling and switching the clutch are integrated into the driving motor to constitute the transmission mechanism, and a wireless controller is also applied to obviate the manual clutch control and provide the simple, quick, accurate, and secure control.

### FIELD OF THE INVENTION

The present invention relates to a clutch driving structure coupled to a driving motor, and more particularly to an apparatus that integrate the clutch driving structure with the driving motor and utilizes a wireless controller to obviate the manual clutch control.

### BACKGROUND OF THE INVENTION

As shown in FIG. 1, the assembly of the clutch 4′ of the transmission apparatus of the conventional motor-driven roller door is shown. The clutch 4′ includes an insertion rod 41′, which is controlled to extend or shrink. The insertion rod 41′ is inserted into a hole 111 of a clutch plate 11′ to lock the clutch plate 11′ on a stationary plate 1′ immovably. Accordingly, a driving motor 3′ is rotated on the clutch plate 11′ in the planet rotation manner. In the power cut, the insertion rod 41′ of the clutch 4′ can be shrunk to be separated from the hole 111′ of the clutch plate 11′ and to separate the clutch plate 11′ from its locking position for being rotated with a hub 2′. There is no loading between the driving motor 3′ and the clutch 11′ so the hub 2′ is idled on the rolling rod. Consequently, the roller door can be opened and closed lightly and quickly.

However, the above-mentioned hole 111′ for the insertion rod 41′ of the clutch 4′ is designed to be a single. Accordingly, if it is desired to lock the insertion rod 41′ again, the hole 111′ of the clutch plate 11′ must be turned back to face the insertion rod 41′ and automatically lock the insertion rod 41′. It is not easy to embody this locking manner on the single hole 111′. If the hole 111′ is damaged, the clutch plate 11′ must be replaced entirely. That wastes production cost and extends maintenance and assembly time. Since the clutch 4′ of the transmission apparatus of the motor-driven roller door is of a single-hole type, it is not easy to operate it and bring it into practice. Besides, its maintenance does not meet the economic benefits.

### SUMMARY OF THE INVENTION

In view of the drawbacks of the conventional clutch of the motor-driven roller door in assembly and maintenance, the present invention provides a clutch driving structure coupled to a driving motor to facilitate and mature the assembly and maintenance of the transmission apparatus of the roller door.

It is a main object of the present invention to provide a clutch driving structure coupled to a driving motor, wherein when the driving structure needs to be maintained, the entire driving motor can be detached from the stationary plate solely before maintenance or replacement. Accordingly, the convenient maintenance is provided. The present invention not only simplifies the conventional composition components of the transmission apparatus of the roller door but also reduces the production cost and provides the simple, quick, accurate, and secure control.

It is another object of the present invention to provide a wireless controller to switch the clutch and facilitate the clutch control. In the power cut, the clutch can be switched by means of the wireless controller. Consequently, the clutch driving structure with the function of automatic switch is thus accomplished.

Other objects and features of the present invention will become apparent from the following detailed description when taken in conjunction with the drawings in which:

### BRIEF DESCRIPTION OF THE DRAWINGS

FIG. 1 is an exploded view showing the assembly of the clutch of the transmission apparatus of the conventional motor-driven roller door.

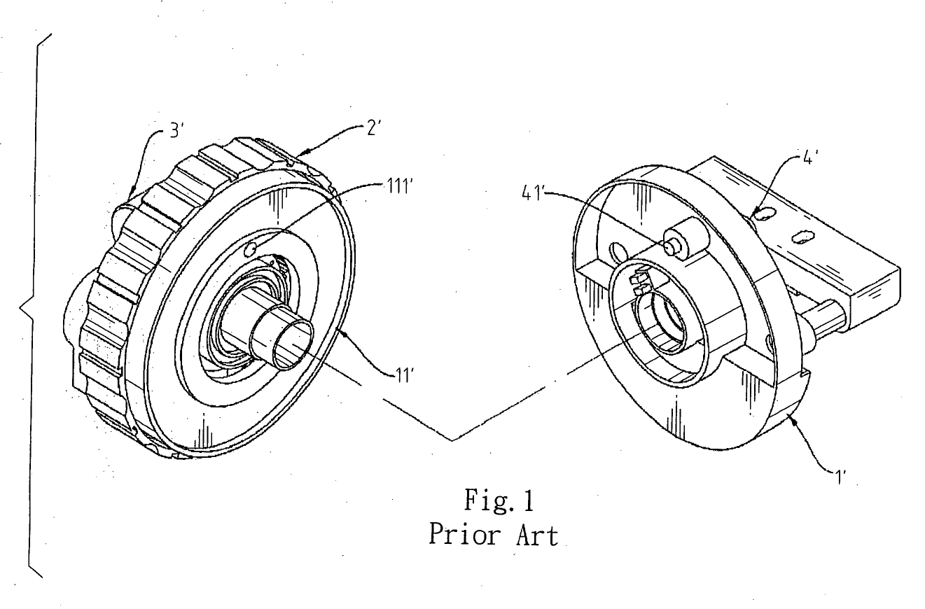

FIG. 2 is an elevational view showing the driving motor inside which the clutch driving structure of the present invention is mounted.

FIG. 3 is an elevational exploded view showing the clutch driving structure of the present invention.

FIG. 4 is a cross-sectional view taken along the line 4-4 of FIG. 2 and viewed in the direction of the arrows.

FIG. 5 is a schematic view showing the usage of the clutch driving structure of FIG. 4.

FIG. 6 is a schematic view showing a wireless control example for controlling the clutch driving structure of the present invention.

FIG. 7 is a schematic view showing another wireless control example for controlling the clutch driving structure of the present invention.

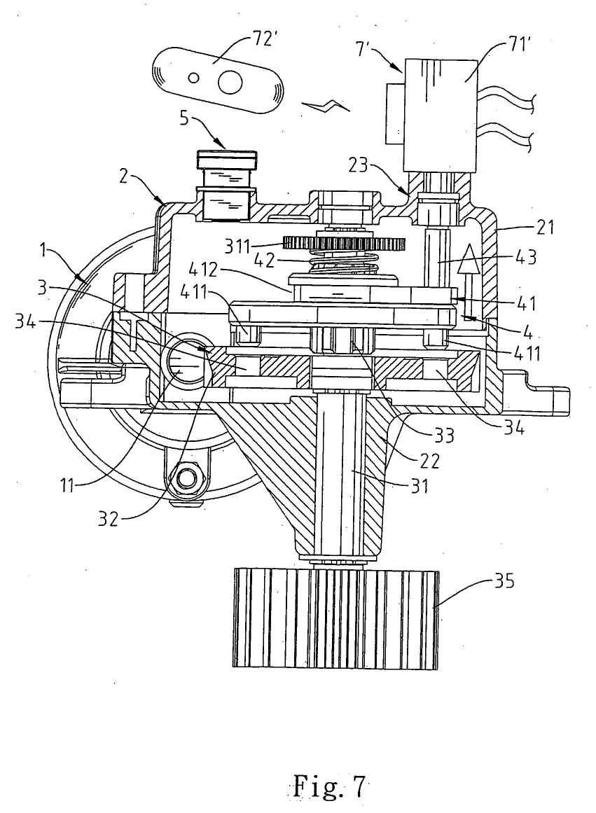

FIG. 8 is a schematic view showing the control of the clutch driving structure of the present invention.

FIG. 9 is a schematic view showing the use of the clutch driving structure of the present invention.

### DETAILED DESCRIPTION OF THE PREFERRED EMBODIMENT

The above-mentioned features and advantages of this invention, and the manner of attaining them, will become more apparent and the invention will be better understood by reference to the following description of embodiments of the invention taken in conjunction with the drawings.

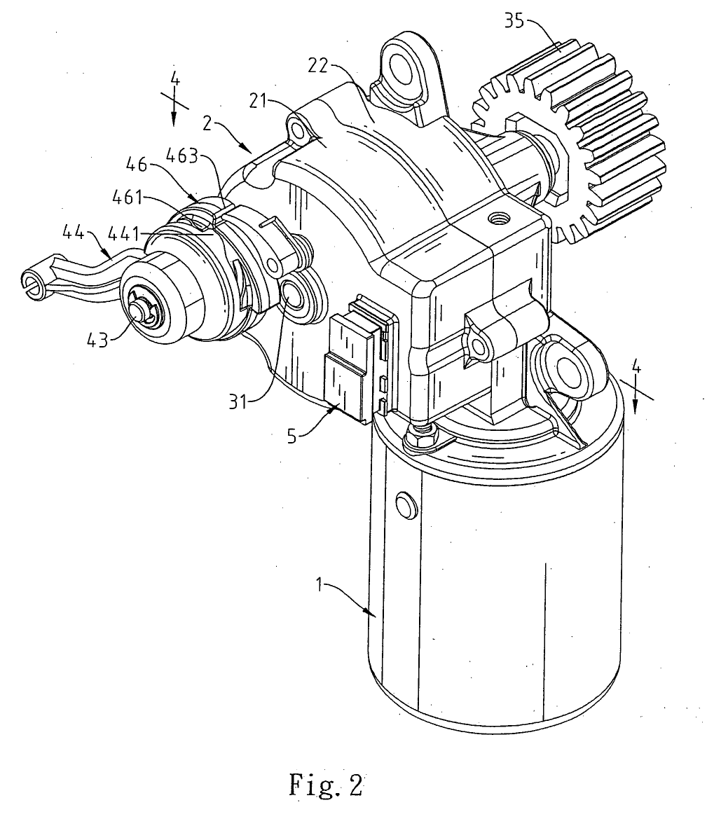

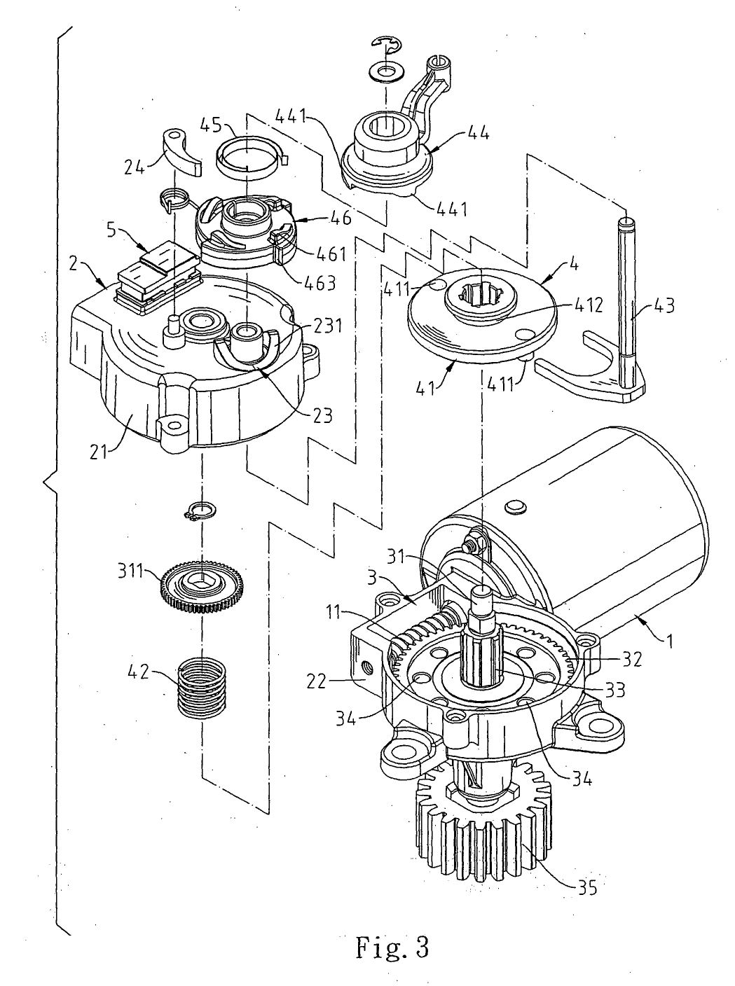

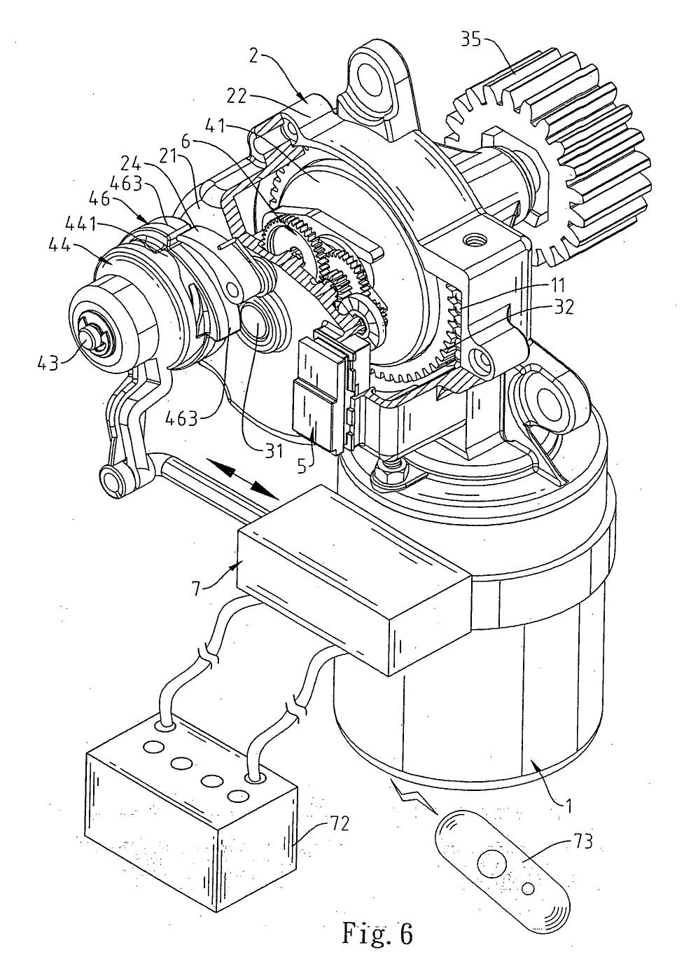

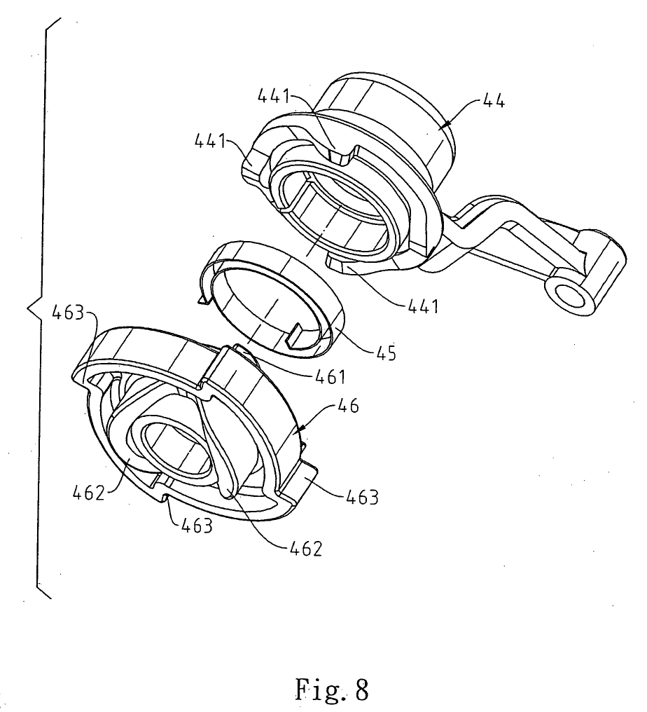

Referring to FIG. 2, FIG. 3, FIG. 6, and FIG. 8, a clutch driving structure coupled to a driving motor of the present invention is shown, wherein the driving motor 1 comprises a retarder 3, a clutch 4, an electronic pedometer 5, and a door position controller 6 mounted inside a housing 2 on the driving motor 1.

A worm main shaft 11 is extended into the housing 12 from the driving motor 1 to rotate a worm main shaft 11 of the retarder 3.

The housing 2 comprises an upper housing 21 having a curved base 23 and a lower housing 22, wherein the curved base 23 includes two symmetric U-shaped notches 231. A movable stopper 24 is mounted near the U-shaped notches 231.

The retarder 3 comprises a transmission main shaft 31 and a worm gear 32. The transmission main shaft 31 is located to pivotally traverse the center of the housing 2 for free rotation, and exposed to the outside of the housing 2 to steadily couple with a transmission gear 35 for rotation together. Besides, on one end of the transmission main shaft 31, a worm gear 32 is pivotally sleeved and a rack hub 33 is mounted. The worm gear 32 is engaged and rotated with the worm main shaft 11, and thereby idled on the transmission main shaft 31. Several clutch holes 34 are formed on the surface of the worm gear 32. In addition, a gear 311 is sleeved on the transmission main shaft 31 on one side of the rack hub 33 so that the transmission main shaft 31 can drive the door position controller 6 through the gear 311.

The clutch 4 comprises a clutch plate 41, a push spring 42, a lever 43, a clutch wrench 44, an elastomer 45, and a clutch rotating plate 46. The clutch plate 41 can be pivotally sleeved onto the rack hub 33 on the end of the transmission main shaft 31 to engage with it, and freely slideable in an axial direction. The clutch plate 41 further comprises several detents 411 on a surface corresponding to the worm gear 32. The detents 411 can be randomly correspondingly inserted into the clutch holes 34 on the surface of the worm gear 32 such that the worm gear 32 can rotate the clutch plate 41 and thus drive the transmission main shaft 31. Because of the engagement between a hub gear of the clutch plate 41 and the rack hub 33, the transmission main shaft 31 is driven and rotated.

Besides, a groove 412 is formed on a lateral surface of the clutch plate 41. The push spring 42 is mounted on a lateral side of the clutch plate 41 for push, thereby allowing the clutch plate 41 to keep rotating with the worm gear 32 in a normal condition. The lever 43 is of a rod having a U-shaped clip for clipping the groove 412 formed on the lateral surface of the clutch plate 41. The rear end of the rod of the lever 43 is extended to penetrate the clutch rotating plate 46 and reach the outside of the housing 2 for being connected with the clutch wrench 44, wherein several pallets 441, 461 are mounted on the opposite surfaces of the clutch wrench 44′ and the clutch rotating plate 46 at equal distance from one another. The pallets 441 and the pallets 461 are mounted to face different directions so that the clutch rotating plate 46 can be rotated by the unidirectional rotation of the clutch wrench 44, wherein the elastomer 45 is mounted between the clutch wrench 44 and the clutch rotating plate 46. The clutch wrench 44 is mounted on the clutch rotating plate 46, and the clutch rotating plate 46 is mounted on the curved base 23. When these components are positioned, the clutch rotating plate 46 is mounted to abut against the stopper 24 such that the stopper 24 can be leant against the raised rib 463, which is mounted on the periphery of the clutch rotating plate 46, to prevent it from reverse rotation.

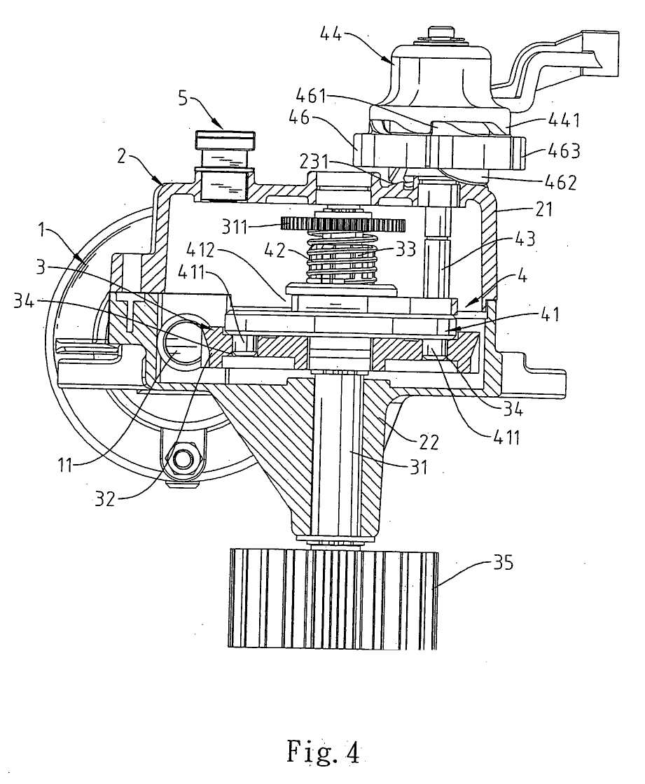

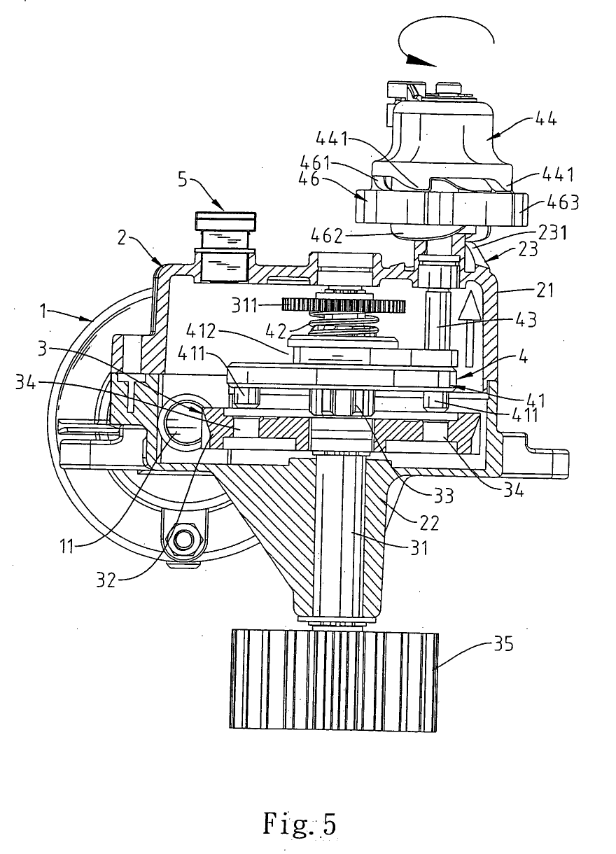

As shown in FIG. 4 and FIG. 5, when the clutch wrench 44 is shifted, the clutch rotating plate 46 is driven by the clutch wrench 44 to make a pivotal rotation. After the clutch wrench 44 is rotated at about 90 degrees, the lever 43 is extended out of the housing 2 to simultaneously shift the clutch plate 41 so as to separate it from the influence of the worm gear 32. In other words, the detents 411 are separated from the clutch holes 34 by shifting to freely idle the worm gear 32 on the transmission main shaft 31 without rotating the transmission main shaft 31 for forming a free rotation without loading. Accordingly, in the normal condition, the driving motor 1 drives the transmission main shaft 31 to perform transmission. In the power cut, the pivotal rotation direction of the clutch wrench 44 can be switched into the other one. Consequently, the purpose of automatic switching and controlling the clutch driving structure is thus achieved.

When the clutch wrench 44 is rotated at about 90 degrees, the pallets 461 of the clutch rotating plate 46 are pushed by the rotation of the pallets 441 of the clutch wrench 44, and the symmetric raised curved bases 462, which are mounted under the clutch rotating plate 46, are driven by the rotating of the clutch rotating plate 46. Accordingly, the symmetric raised curved bases 462 are shifted on the symmetric U-shaped notches 231 for upward lifting up the clutch rotating plate 46 by use of the curved surfaces of the U-shaped notches so as to further drive the lever 43.

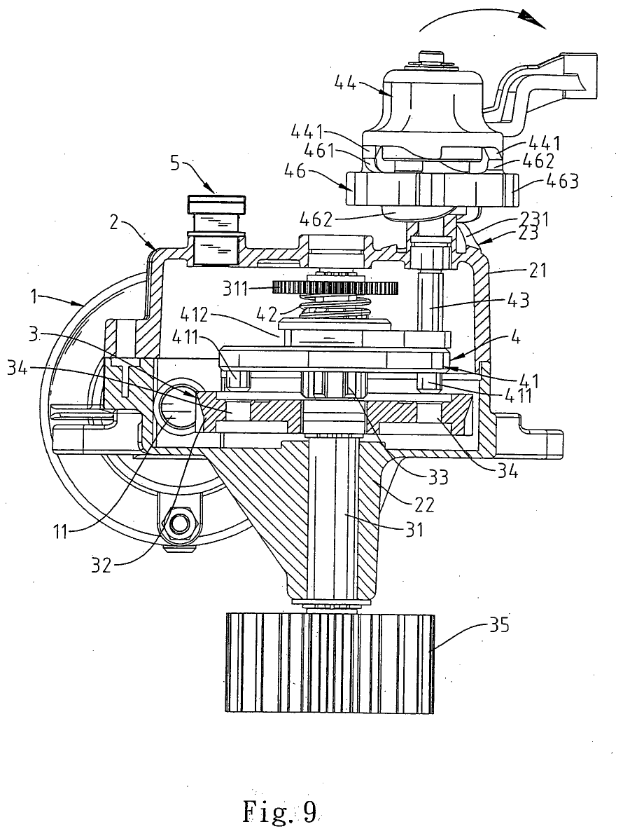

Referring to FIG. 5 and FIG. 9, if it is decided to recover the position of the clutch wrench 44, the reverse rotation is then performed. The clutch wrench 44 must be further rotated at about 90 degrees to recover its original position. Accordingly, the pallets 441 are shifted along the pallets 461 of the clutch rotating plate 46 to get across the top ends of the pallets 461 and reach the backside of the pallets 461. At this moment, the clutch rotating plate 46 is not rotated, so the lever 43 is not driven. Accordingly, the clutch wrench 44 must be rotated at about 90 degrees to further rotate the clutch rotating plate 46. The symmetric raised curved bases 462 are inserted into the U-shaped notches 231 by the rotation of the clutch rotating plate 46. At this moment, if the clutch wrench 44 is reversely rotated at 90 degrees in accordance with the aforementioned method, the clutch wrench 44 is further rotated to recover its position. Consequently, the purpose of automatic switching and controlling the clutch driving structure is thus achieved.

Referring further to FIG. 6, the switch of the clutch is of the typically manually driving type, or a wireless controller 7 may be applied to pivotally rotate the clutch wrench 44. The wireless controller 7 comprises an electromagnetic valve 71 and a storage battery 72. The electromagnetic valve 71 is pivotally connected to the clutch wrench 44. In the power cut, a remote controller 73 is applied for controlling the electromagnetic valve 71 to pivotally rotate the clutch wrench 44 to separate the clutch 4 from the worm gear 32, thereby idling the worm gear 32 on the transmission main shaft 31 without the loading for rotating the transmission main shaft 31. Furthermore, the electronic pedometer 5, which is mounted on the driving motor 1, is applied for detection and sensing so as to calculate the driving time for forward and backward rotations and thereby achieve the limit position control of the roller door.

In an alternative way, a wireless controller 7″ mounted on the lever 43 may be applied to control the clutch 4 in a wireless manner, wherein an electromagnetic valve 71′ is fixed on the lever 43 directly. When the electromagnetic valve 71′ is actuated by a remote controller 72″, the suction force formed by the electromagnetic valve 71′ shifts the lever 43 to separate the clutch plate 41 from the worm gear 32 for idling the worm gear 32 on the transmission main shaft 31 without the loading for rotating the transmission main shaft 31. In the power cut, the clutch plate 41 of the clutch 4 can be switched. Consequently, the clutch driving structure with the function of automatic switch is thus accomplished.

On the basis of the description mentioned above, in the maintenance, if the clutch driving structure of the present invention, which is coupled to a driving motor, is failure, the entire driving motor 1 can be solely detached from the stationary plate for providing the convenient maintenance or replacement. The present invention not only simplifies the composition components of the transmission apparatus of the conventional roller door but also reduces the production cost and provides the simple, quick, accurate, and secure control. In addition, the wireless controllers 7, 7′ can be applied to switch the clutch wrench 44 and rotate the lever 43 for controlling the switch of the clutch 4, thereby providing the convenient wireless control for switching the clutch. Consequently, it is easier to transmit, assemble, and maintain the roller door.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

1. A clutch driving structure coupled to a driving motor, comprising:
a retarder, a clutch, an electronic pedometer, and a door position controller mounted inside a housing on said driving motor, wherein:
said retarder comprises a transmission main shaft and a worm gear, said transmission main shaft being located to pivotally traverse the center of said housing to be freely rotated thereon and exposed to the outside of said housing for further steadily coupling and rotating with a transmission gear, said worm gear being pivotally sleeved on one end of said transmission main shaft and a rack hub being mounted as well, said worm gear being engaged and rotated with a worm main shaft of said driving motor to keep idling on said transmission main shaft, a plurality of clutch holes being formed on a surface of said worm gear; and
said clutch comprises a clutch plate, a push spring, a lever, a clutch wrench, an elastomer, and a clutch rotating plate, said clutch plate being slideable on said rack hub to form a clutch transmission action with said worm gear, said push spring being mounted for pushing said clutch plate to allow said clutch plate to keep wedging and rotating with said worm gear in a normal condition, said lever being coupled with a groove formed on one lateral surface of said clutch plate for sliding said clutch plate by pull, several detents being mounted on a surface of the clutch plate of the clutch corresponding to said worn gear, said detents being respectively inserted into said clutch holes to allow said worn gear to rotate said clutch plate and drive said transmission main shaft, said clutch wrench being coupled with a rear end of said lever exposed to the outside of said housing for shifting said clutch plate to separate said clutch plate from the action of said worm gear and allow said transmission main shaft to be freely rotated without loading, said elastomer being mounted between said clutch wrench and the clutch rotating plate when they are coupled with one another, a plurality of pallets being mounted respectively on opposite surfaces of said clutch wrench and said clutch rotating plate at equal distance from one another to face different directions, said clutch rotating plate being mounted on a curved base to allow symmetric raised curved bases mounted under the clutch rotating plate to be shifted on symmetric U-shaped notches of said curved base for upward lifting up said clutch rotating plate by use of curved surfaces of said U-shaped notches so as to further drive the lever.

2. The clutch driving structure coupled to the driving motor of claim 1, wherein said curved base is mounted on one side of said housing, and said curved base further comprises said symmetric U-shaped notches.

3. The clutch driving structure coupled to the driving motor of claim 1, wherein said wireless controller is located on said clutch wrench, and said wireless controller comprises an electromagnetic valve and a storage battery for pivotally rotating said clutch wrench by use of said electromagnetic valve to control the action of said clutch.

4. The clutch driving structure coupled to the driving motor of claim 1, wherein an electromagnetic valve is pivotally connected to said axial rod for shifting said axial rod and pivotally rotating said clutch wrench to control the action of the clutch.

5. The clutch driving structure coupled to the driving motor of claim 1, wherein when said clutch rotating plate is positioned, a stopper can be applied to lean against a raised rib, which is mounted on the periphery of the clutch rotating plate, to prevent said clutch rotating plate from reverse rotation.
